(19) United States
(12) Patent Application Publication
(10) Pub. No.: US 2023/0214902 A1
(43) Pub. Date: Jul. 6, 2023

(54) Templates For Curated Collections

(71) Applicant: CurioSearch DBA Materiall, Milpitas, CA (US)

(72) Inventors: Bharat Vijay, FREMONT, CA (US); Jayanth Vijayaraghavan, Palo Alto, CA (US); Rajiv Ramaratnam, Morgan Hill, CA (US)

(73) Assignee: CurioSearch DBA Materiall, Milpitas, CA (US)

(21) Appl. No.: 17/570,320

(22) Filed: Jan. 6, 2022

(51) Int. Cl. G06Q 30/06

(52) U.S. Cl. CPC G06Q 30/0631; G06Q 30/0641

(57) ABSTRACT

Described herein is a method and system for creating templates. Themes are identified based on textual and image processing of media, wherein each of the themes is one or a combination of entities such as occasions, events, festivals, and seasonal wear. An attribute classification model is applied and thereafter attributes are identified based on textual and image processing of the media. Themes(s) are mapped to the attributes to create a template(s), wherein a map is a rule connecting themes to attributes. The template comprises a theme and its associated attributes, and the values of the attributes. A similarity search model is applied to create an extended range of templates from an initial template. The template is not a product and does not have a state. An extended range of templates are stored in a database.

### BACKGROUND

This invention in general relates to ecommerce, and specifically relates to a method and system of engaging with an online consumer in an ecommerce site.

Existing electronic/online catalogues of products and services presented to consumers in an ecommerce site do not satisfactorily reflect the consumer’s interest.

Currently, online stores have a low conversion rate compared to brick-and-mortar stores. In order to increase purchase conversion rates in ecommerce sites, much of the desirable offline store experience needs to be brought into online stores. The offline stores have the ability to sort and present items in creative ways, for example through organized and attractive presentations of apparel on mannequins and display sets. Currently, in the online world, the information relating to products and services is ineffectively presented to the consumer, as the information is either highly scattered, or jumbled up, or each product overshadows the other, or the product selection is too vast and diluted. The online shopping experience now resembles visiting a seemingly disorganized large warehouse of items in which the customer gets lost in a disorganized and ineffective presentation of items.

Therefore, there is an unmet need for effective product and service presentations in online stores that meets consumer expectations and increases online purchase conversion rates.

### SUMMARY OF THE INVENTION

A collection presented to a consumer on an ecommerce website is a grouping of products than can be automatically created based on worldwide trends in apparel and accessories, seasonal trends, attribute and price sensitivity. In addition collections can be configured to filter out low performing and poorly reviewed products.

Described herein is a method and system for creating templates. Themes are identified based on textual and image processing of media, wherein each of the themes is one or a combination of entities such as occasions, events, festivals, and seasonal wear. An attribute classification model is applied and thereafter attributes are identified based on textual and image processing of the media. Themes(s) are mapped to the attributes to create a template(s), wherein a map is a rule connecting themes to attributes. The template comprises a theme and its associated attributes, and the values of the attributes. A similarity search model is applied to create an extended range of templates from an initial template. The template is not a product and does not have a state. An extended range of templates are stored in a database.

Products can be showcased to consumer that are fine tuned to the persona of the shopper. For example, for each Zodiac sign, particular styles are chosen and applied to the inventory of apparel. During festivals, thematic collections are created and presented to the customer.

A curated collection consists of a set of defined parameters for a particular theme. The themes are then applied to a retailer’s catalogue for selecting products from that catalogue, thereafter creating a curated collection of those products. Curated collections allow the retailer’s consumers to browse the inventory of the retailer in an intelligent and thematic manner.

The templates encapsulate various attributes of the product. For example, in the case of apparel, themes could encapsulate color, fit, length, type, patterns, styles; and, could also map these attributes to concepts like Zodiac signs. It is well known that consumers with particular Zodiac signs have propensities for specific colors, styles and patterns. These templates can either be captured as images or as a set of attributes. These templates are mapped to a retailers catalogue using a combination of image, text processing, retailers own cataloguing, and data tagging. Themes can be picked up either by human intelligence, or by a designer, or a domain expert. The above-mentioned template based approach covers all types of merchandising that requires visual and nonvisual attribute matching.

Advantageously, templates are developed and refined over time. Machine learning models are applied to periodically enrich these templates. Subject matter experts may also contribute to refinement of the templates. These enriched templates are stored in a database, and are applied to apparels and accessories at any point in time to create curated collections. The template technique is more effective in displaying more relevant items of interests to customer, along with minimal latency, when compared to the currently applied techniques (computationally expensive and non-comprehensive) of identifying items when the customer visits a portal or picks/browses over an object and is looking for items of interest.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a template creation system. The template creation system also includes a processor; and a memory containing instructions, which when executed by the processor, configure the system to: identify themes based on textual and image processing of media, where each of said themes is one or a combination of entities such as occasions, events, festivals, and seasonal wear; apply an attribute classification model and thereafter identify attributes based on textual and image processing of said media; map said themes to said attributes to create a template(s), where a map is a rule connecting themes to attributes, where said template may include a theme and its associated said attributes, and values of the attributes; and apply a similarity search model to create an extended range of templates from said template, where said template is not a product and does not have a state; and store said extended range of templates in a database. Other embodiments of this aspect include corresponding computer systems, apparatus, and computer programs recorded on one or more computer storage devices, each configured to perform the actions of the methods.

One general aspect includes a computer implemented method of creating a template. The computer implemented method of creating also includes identifying themes based on textual and image processing of media, where each of said themes is one or a combination of entities such as occasions, events, festivals, and seasonal wear; applying an attribute classification model and thereafter identify attributes based on textual and image processing of media; mapping said theme(s) to said attributes to create a template(s), where a map is a rule connecting themes to attributes, where said template may include a theme and its associated said attributes, and values of the attributes; and applying a similarity search model to create an extended range of templates from said template, where said template is not a product and does not have a state; and storing said extended range of templates in a database. Other embodiments of this aspect include corresponding computer systems, apparatus, and computer programs recorded on one or more computer storage devices, each configured to perform the actions of the methods.

Implementations may include one or more of the following features. The method where said attributes are automatically inferred by a machine learning (ml) algorithm. Said retailer installs a software application in their online store, where said application applies said template(s) to an electronic catalog of a retailer to automatically create a curated collection of items to use in said website. Said template is a blueprint for a set of collections that have the same attributes and similar themes. The method may include the step of defining said template by verticals, categories, attributes, metrics, and text filters. Said template is a global template that is applied to an online store to create a collection. Said template is a local template that can only be applied within a store to create a collection. Said template is a system template that is created by developers based on store metrics. Said template is a trending template that creates collections of products that are top sellers. Said template is a brand name look alike template that is applied to said electronic catalog to create collections of products from a store that resemble high end branded products. Said template is a celebrity template that is applied to said electronic catalog to create collections of products from a store’s catalogue that resemble outfits worn by celebrities. Said templates are created by developers based on system metrics in combination with attributes, filters, metrics and categories. Initial rules for template attributes are entered by a subject matter expert, and said subject matter expert can alter a collection by adding or removing items from said collection. The method may include: uploading image(s) via at least one computing device from a console or software application; and qualifying, via the at least one computing device, a template derived from said image(s) by automatically selecting additional attributes based on image classification for each image uploaded. Implementations of the described techniques may include hardware, a method or process, or computer software on a computer-accessible medium.

One general aspect includes a computer implemented system for creating an extended range of templates. The computer implemented system also includes a master database that includes a database of a first set of templates, collection database, and catalog database, where events of user clicks, carts, and attribute data of said online consumer are merged into said master database, and where said electronic catalog is segmented and classified into a lowest category to reduce complexity; Other embodiments of this aspect include corresponding computer systems, apparatus, and computer programs recorded on one or more computer storage devices, each configured to perform the actions of the methods.

### BRIEF DESCRIPTION OF FIGURES

FIG. 1 illustrates the online ecommerce ecosystem comprising templates and collections.

FIG. 2 illustrates the method of creating a template.

FIG. 3 illustrates a system for generating templates.

FIG. 4A exemplarily illustrates the step of selecting a category during the process of creating a template.

FIG. 4B exemplarily illustrates the step of selecting a sub-category (attribute) during the process of creating a template.

FIG. 5A exemplarily illustrates the step of selecting other attributes during the process of creating a template.

FIG. 5B exemplarily illustrates the step of selecting a sleeve length attribute during the process of creating a template.

FIG. 6A exemplarily illustrates the step of selecting one or more color attributes during the process of creating a template.

FIG. 6B exemplarily illustrates the step of a subject matter expert optionally including thresholds for clicks, carts and orders on products for creation of a template.

FIG. 7A exemplarily illustrates the step of a subject matter expert refining a template by adding text.

FIG. 7B exemplarily illustrates the step wherein the subject matter expert saves the template with a suitable tag after refining the template.

FIG. 8A exemplarily illustrates the step wherein the subject matter expert chooses the template.

FIG. 8B exemplarily illustrates the step wherein the subject matter expert creates and saves the template by choosing a tag and a template name.

FIG. 9 illustrates the training for attributes using an attribute classification model.

FIG. 10 illustrates the probabilities based on the attributes.

### DETAILED DESCRIPTION

In the following description, for purposes of explanation, numerous specific details are set forth in order to provide a thorough understanding of the invention. It will be apparent, however, to one skilled in the art that the invention may be practiced without these specific details. In other instances, structures and devices are shown in block diagram form only in order to avoid obscuring the invention.

Reference in this specification to “one embodiment” or “an embodiment” means that a particular feature, structure, or characteristic described in connection with the embodiment is included in at least one embodiment of the invention. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Moreover, although the following description contains many specifics for the purposes of illustration, anyone skilled in the art will appreciate that many variations and/or alterations to said details are within the scope of the present invention. Similarly, although many of the features of the present invention are described in terms of each other, or in conjunction with each other, one skilled in the art will appreciate that many of these features can be provided independently of other features. Accordingly, this description of the invention is set forth without any loss of generality to, and without imposing limitations upon, the invention.

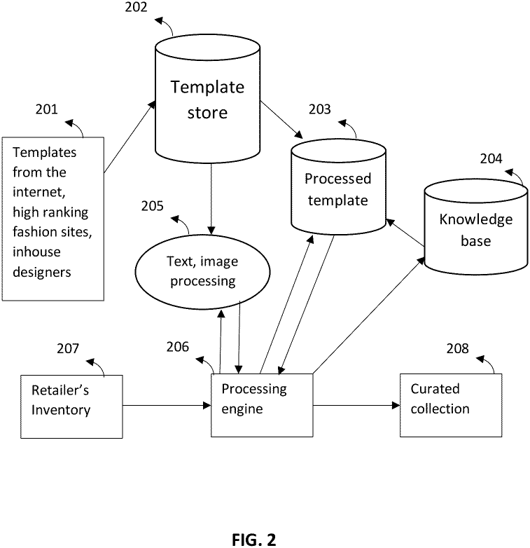

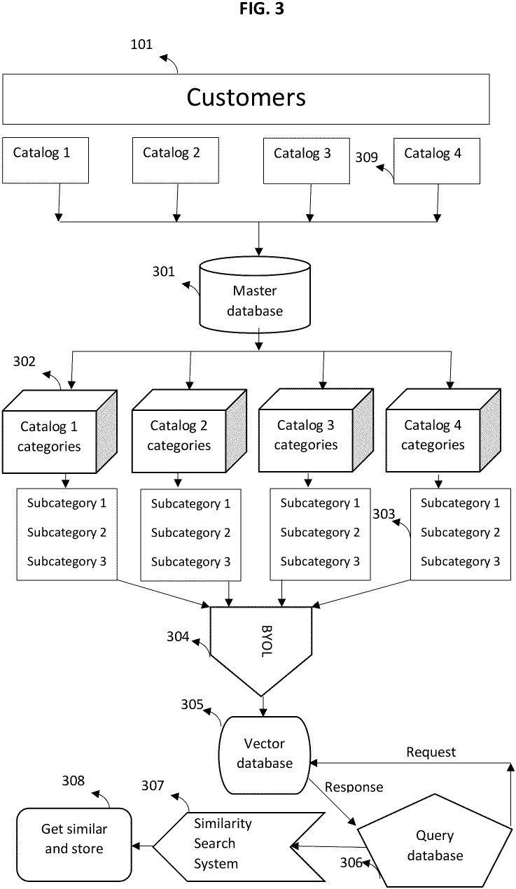

Templates are abstractions of collections. A template may be considered a blueprint for a set of collections that have the same attributes and similar themes. The same template can be used across several online stores. Templates are defined by verticals, categories, attributes, metrics and text filters. An extended range of templates is created automatically using the system and automated processes illustrated in FIG. 2 and FIG. 3. Unlike a collection, a template does not contain products and does not have states. There are two types of templates, Global and Local. Global templates can be used on any online store supported in the platform, for example it can be used on a Shopify™ store. Local templates may only be used within a store.

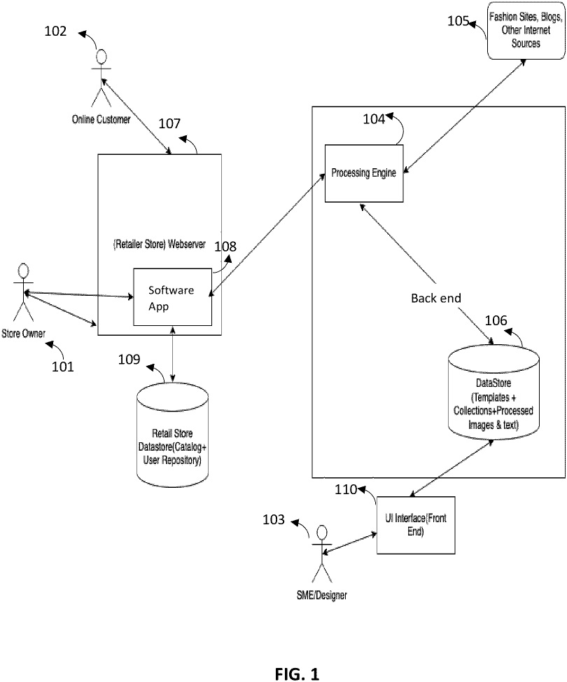

FIG. 1 illustrates an online ecommerce ecosystem comprising templates and collections.

Described herein is a method and system for creating templates. Themes are identified based on textual and image processing of media, wherein each of the themes is one or a combination of entities such as occasions, events, festivals, and seasonal wear.

An attribute classification model is applied and thereafter attributes are identified based on textual and image processing of the media 105.

Themes(s) are mapped to the attributes to create a template(s), wherein a map is a rule connecting themes to attributes. The template comprises a theme and its associated attributes, and the values of the attributes.

A similarity search model is applied to create an extended range of templates from an initial template. The template is not a product and does not have a state. An extended range of templates are stored in a database.

A software application 108 applies templates to create collections from the retail store catalogues 109 (of the storeowner 101) for the online consumer 102. A processing engine 104 processing information from information sources (media) 105 and data stores 106, provides templates to the webserver 107. A subject matter expert 103, through a user interface 110, aids in the generation of an initial set of templates.

Below is an example of a simple template.
Name: Red Flowers
Category: Women
Attributes: Red, floral, vibrant
Description: “Stand out with our trendy red collection”

In one store, this template may be used to create a collection of red dresses with a floral pattern. The same template can be used in another store that specializes in sarees to create a collection of red sarees with floral patterns.

System templates are special templates that are created by developers based on store metrics. Examples of system templates are described below.

“Trending Template”: A template to create collections of products that are ‘trending’ i.e.: selling more since the last week or month.

“Brand Name Look Alike Template”: A template to create collections of products from a store that resemble “high end products”

“Celebrity Template”: A template to create collections of products from a store’s catalogue that resemble outfits worn by Celebrities at an event, etc.

The notation for a template is shown below:

▫Template : <template name><attribute 1..n><description><source>

▫Attribute : <category><brand><color><neckline><design><....><model▫face image><model▫body▫type>

<vibrant>:<mapping regular English to catalogue attributes>

A subject matter expert (SME) 103 can use a template to create a collection for a store 107. The SME 103 can then ‘tweak’ the collection by adding or removing items from a collection.

A software application 108 is provided to automatically create templates, and to apply those templates to the store’s catalogue to create curated collections.

These collections can be immediately offered to a storeowner 101 to use on his or her website.

As an intermediate step, an SME 103 can choose to tweak the collection before presenting to a store owner 101.

FIG. 2 illustrates the method of creating a template. Templates 201 stored in a template store 202 are further processed 203 by applying a processing engine 206 to text and image processing 205 and a knowledge base 204, and further applying these templates to a retailer’s inventory 207 to create curated collections 208.

An initial set of templates can be created from existing collections created by SMEs 103 using a console, Machine Learning support with text and image analytics, using the attributes, filters, metrics and categories of the collection. In one embodiment, a console is provided to a subject matter expert (103) to create an initial set of templates that includes certain custom attributes (such as Comfortable, Vibrant, etc.). The SME 103 can define these custom attributes using other attributes such as color, style, design etc.

In another embodiment, system templates can be created by developers based on system metrics in combination with attributes, filters, metrics, and categories.

SMEs 103 can create an initial set of templates with the aid of artificial intelligence (AI) tools from a selection of attributes, filters, metrics, and categories.

One of the techniques used to create templates is from uploaded images from a console or App.

Console: In the collection creation page, an SME 103 or designer can create a template by uploading one or more images product(s). For example, this image may be one of a celebrity wearing a certain outfit at an award show. After uploading the images, the SME 103 can optionally further qualify it by choosing additional attributes for each image uploaded (Color, dress style, collar type, etc.)

A processing engine 206 uses the above information to create a template.

FIG. 3 illustrates the system for generating an extended range of templates.

Block 309 represents the retailer’s 101 electronic catalogue. The customer is the online retailer 101, and the consumer 102 is the end user. The master database 301 includes the template database, collection database and catalogue database. Merge the user events, i.e., the user clicks carts/events, and attribute data into the master database 301. Determine the similarity between categories and reduce complexity by classifying at the lowest level subcategory 303. The catalogue 302 is segmented into sub categories 303. For example, considering the men’s L0 L1 shirt size category. Exemplarily, in order to search for a Men’s polo shirt, select a subcategory 303 called Polo neck, and intelligently analyse the text and image, and determine that the product is classified under the Polo neck sub category 303, and thereafter get similar within the Polo neck subcategory 303. After a Bootstrap Your Own Latent (BYOL) 304, execute the “get similar” 308 step by applying vector similarity using a similarity search system 307. Facebook AI Similarity Search (FAISS) is an example of such a similarity search system 307. The step of determining vector similarity is performed by querying through applying a request from query database 306 on a set of vectors stored in a vector database 305.

The following steps highlight the method of extending the range of template using similar.

Find the embedding vector for every image in the dataset by performing a forward pass on a trained BYOL encoder using all images from the dataset.

Use FAISS, a library for efficient similarity search and clustering of dense vectors. Create a FAISS index from the embedding. This index is a sorted version of the embedding according to some metric (such as Euclidean distance).

Given a test image, find the embedding and quickly locate the similar images from the created Faiss index. If required, add the new image to the dataset and the embedding to the Faiss index 804.

For a given a set of vectors xi in dimension ‘d’, FAISS builds a data structure in RAM from it. After constructing the data structure, given a new vector x in size ‘d’, FAISS performs the following operation efficiently:

$$\text{argmin i} \left‖\text{xi} - \text{x}\right‖$$

where ||.|| is the Euclidean distance (). FAISS essentially finds the index ‘i’, which contains an embedding vector closest (similar) to the test image’s embedding vector. The Faiss index can then be stored and used for finding similar images.

Template Mapping is based on concepts/themes, attributes and personalized data. A concept/theme is a combination of entities such as occasions, events, festivals, seasonal wear, etc.; along with a description of those entities. Each of these maps to attributes that are entered by a subject matter expert or automatically inferred by a machine learning (ML) algorithm. For e.g., if we define a concept as Vibrant summer collection - map vibrant to colors red green blue and summer to light colors, relaxed fit clothes, etc. This mapping of a theme to a set of attributes is a template. Templates are reusable across multiple stores. Templates can be created through text and image processing. In one embodiment, an extended range of templates by text and image processing, and the processes illustrated in FIG. 3. In an embodiment an extended range of templates are created from an initial set of templates. When image processing is applied to create templates, sample images are used that visually depict a theme/concept, and that have the right set of attributes. Vector similarity is utilized to find similar images and store these as templates. From these templates, collections are created by grouping products that have similar attributes and user metrics.

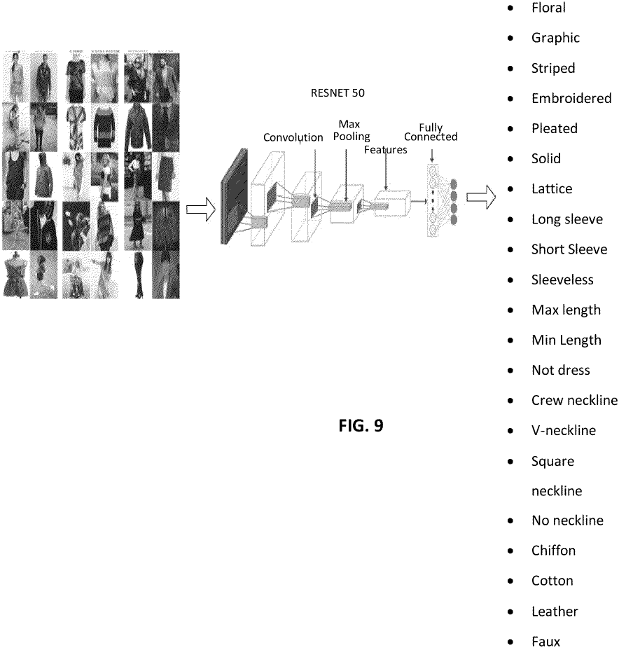

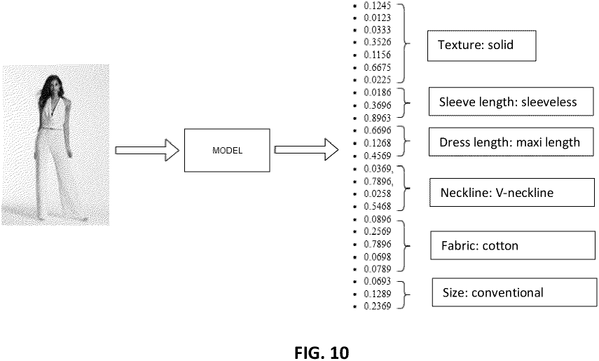

The process of attribute classification is described herein. Attribute classification is considered as a multi-label classification problem. Exemplarily, there are 26 classes in total. Each data in the dataset consists of an image with the corresponding attribute label. FIG. 9 illustrates the training for attributes. Perform supervised learning using the Resnet 50 architecture, and save the trained model. Given a new image (image shown in FIG. 10), the model outputs the probability of each class.

FIG. 10 illustrates the example probabilities determined based on the attributes. There are 26 classes, and only six attributes are required. Therefore, these probabilities are first grouped based on the attribute they belong to, and then the maximum value in each group is selected.

Template definition <Entity Name, Description, attributes like category, style, pattern, image URLs, user metrics like click/cart ratio, click/order ratio>

The master database contains all the template definitions, splits it into multiple flows each per subcategory of a customer, and uses a vector database to store the representations.

Described herein is the process of template sorting using a console. A sorting order can be set for a template while it is being created or updated. The sort order may be alpha-numeric and in ascending or descending order, based on price, available inventory, bestsellers or a custom sort based on clicks, carts and orders on products. Other advanced sorting orders like clicks to order ratio, random order may also be used. Collections created with such a template will use the sort order configured with the respective template.

Described herein is the process of template sorting using a software application. A store owner creating a template through the software application will also be able to set the sort order for the template based on criteria described above. Collections created with such a template will use the same sort order as that specified for the template.

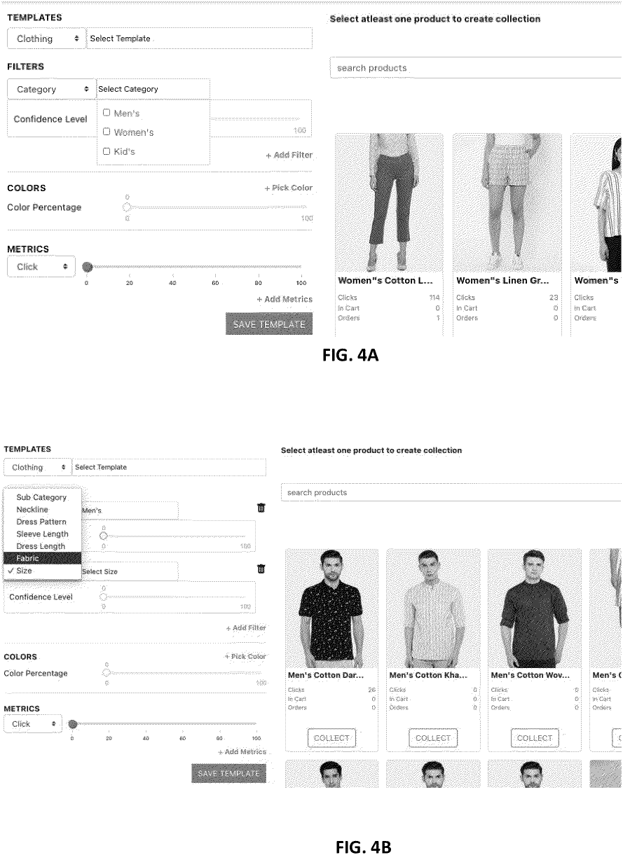

FIG. 4A exemplarily illustrates the step of selecting a category during the process of creating a template, for example the selection of a men’s or woman’s category.

FIG. 4B exemplarily illustrates the step of selecting a sub-category (attribute) during the process of creating a template, for example the selection of a fabric.

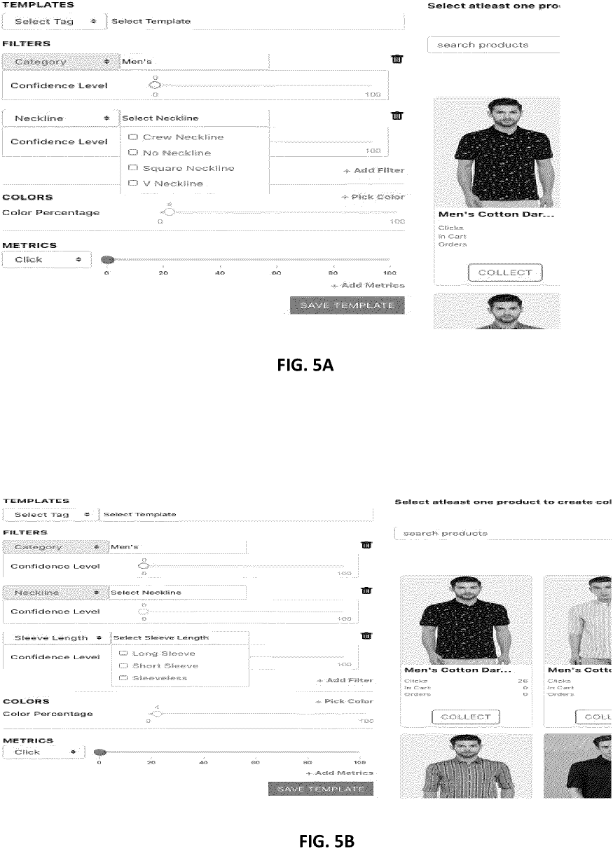

FIG. 5A exemplarily illustrates the step of selecting other attributes during the process of creating a template, for example the selection of a neckline attribute.

FIG. 5B exemplarily illustrates the step of selecting a sleeve length attribute during the process of creating a template.

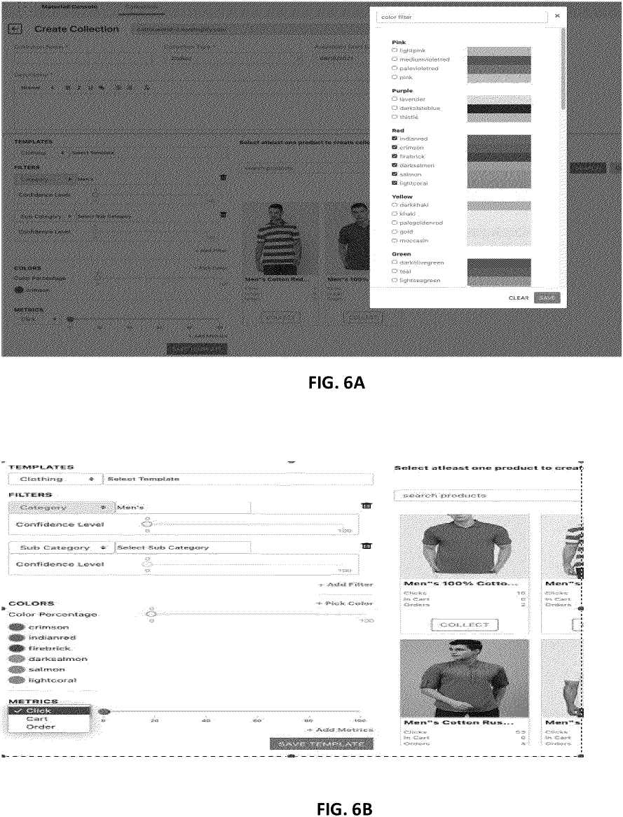

FIG. 6A exemplarily illustrates the step of selecting one or more color attributes during the process of creating a template.

FIG. 6B exemplarily illustrates the step of a subject matter expert optionally including thresholds for clicks, carts and orders on products for creation of a template.

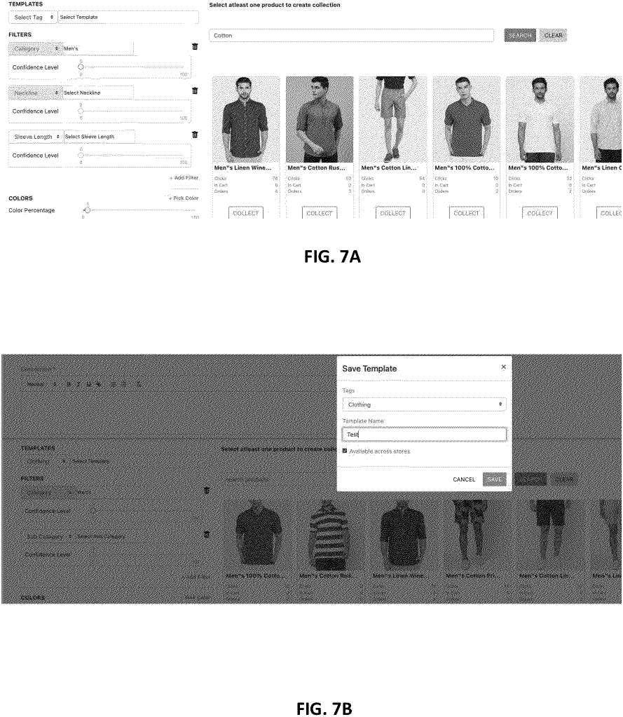

FIG. 7A exemplarily illustrates the step of a subject matter expert refining a template by adding text.

FIG. 7B exemplarily illustrates the step wherein the subject matter expert saves the template with a suitable tag after refining the template. The tag describes the vertical for the template. Examples of tags: All, Clothing, Jewellery, Footwear.

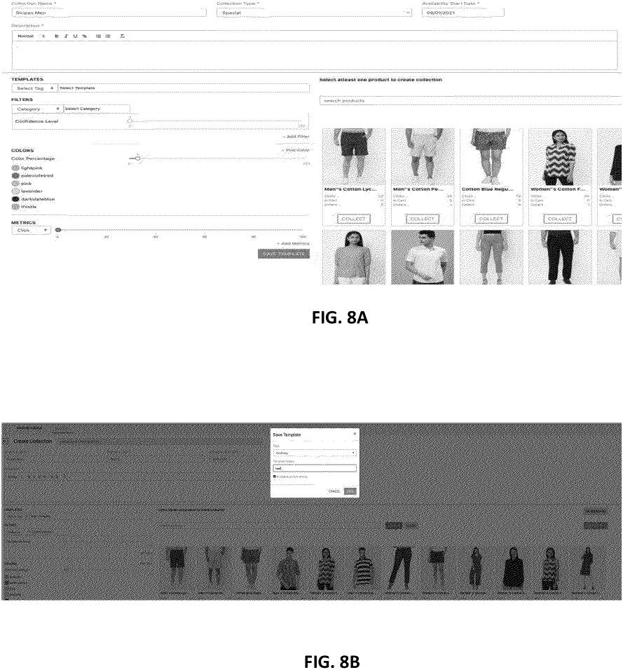

FIG. 8A exemplarily illustrates the step wherein the subject matter expert chooses the template, for example choosing the “Stripes Men” collection.

FIG. 8B exemplarily illustrates the step wherein the subject matter expert creates and saves the template by choosing a tag and a template name.

The processing steps described above may be implemented as modules. As used herein, the term “module” might describe a given unit of functionality that can be performed in accordance with one or more embodiments of the present invention. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skills in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

In general, the modules/routines executed to implement the embodiments of the invention, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations necessary to execute elements involving the various aspects of the invention. Moreover, while the invention has been described in the context of fully functioning computers and computer systems, those skilled in the art will appreciate that the various embodiments of the invention are capable of being distributed as a program product in a variety of forms, and that the invention applies equally regardless of the particular type of machine or computer-readable media used to actually effect the distribution. Examples of computer-readable media include but are not limited to recordable type media such as volatile and non-volatile memory devices, USB and other removable media, hard disk drives, optical disks (e.g., Compact Disk Read-Only Memory (CD ROMS), Digital Versatile Disks, (DVDs), etc.), flash drives among others.

Modules might be implemented using a general-purpose or special-purpose processing engine such as, for example, a microprocessor, controller, or other control logic. In the illustrated example, the modules could be connected to a bus, although any communication medium can be used to facilitate interaction with other components of computing modules or to communicate externally.

The computing server might also include one or more memory modules, simply referred to herein as main memory. For example, preferably random access memory (RAM) or other dynamic memory, might be used for storing information and instructions to be executed by processor. Main memory might also be used for storing temporary variables or other intermediate information during execution of instructions to be executed by a processor. Computing module might likewise include a read only memory (“ROM”) or other static storage device coupled to bus for storing static information and instructions for processor.

The database module might include, for example, a media drive and a storage unit interface. The media drive might include a drive or other mechanism to support fixed or removable storage media. For example, a hard disk drive, an optical disk drive, a CD, DVD or Blu-ray drive (R or RW), or other removable or fixed media drive might be provided. As these examples illustrate, the storage media can include a computer usable storage medium having stored therein computer software or data.

In alternative embodiments, the database modules might include other similar instrumentalities for allowing computer programs or other instructions or data to be loaded into the computing module. Such instrumentalities might include, for example, a fixed or removable storage unit and an interface. Examples of such storage units and interfaces can include a program cartridge and cartridge interface, a removable memory (for example, a flash memory or other removable memory module) and memory slot, a PCMCIA slot and card, and other fixed or removable storage units and interfaces that allow software and data to be transferred from the storage unit to computing module.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

What is claimed is:

1. A template creation system, wherein said template is applied via a computing device to an electronic catalog of items of an online retailer to create a curated collection of items displayed in a website for an online consumer, said template creation system comprising:
a processor; and
a memory containing instructions, which when executed by the processor, configure the system to:
identify themes based on textual and image processing of media, wherein each of said themes is one or a combination of entities such as occasions, events, festivals, and seasonal wear;
apply an attribute classification model and thereafter identify attributes based on textual and image processing of said media;
map said themes to said attributes to create a template(s), wherein a map is a rule connecting themes to attributes, wherein said template comprises a theme and its associated said attributes, and values of the attributes; and
apply a similarity search model to create an extended range of templates from said template, wherein said template is not a product and does not have a state; and
store said extended range of templates in a database.

2. A computer implemented method of creating a template, wherein said template is applied to an electronic catalog of a retailer to create and display a curated collection of items in a website for an online consumer, comprising:
identifying themes based on textual and image processing of media, wherein each of said themes is one or a combination of entities such as occasions, events, festivals, and seasonal wear;
applying an attribute classification model and thereafter identify attributes based on textual and image processing of media;
mapping said theme(s) to said attributes to create a template(s), wherein a map is a rule connecting themes to attributes, wherein said template comprises a theme and its associated said attributes, and values of the attributes; and
applying a similarity search model to create an extended range of templates from said template, wherein said template is not a product and does not have a state; and
storing said extended range of templates in a database.

3. The method of claim 2, wherein said attributes are automatically inferred by a machine learning (ML) algorithm.

4. The method of claim 2, wherein said retailer installs a software application in their online store, wherein said application applies said template(s) to an electronic catalog of a retailer to automatically create a curated collection of items to use in said website.

5. The method of claim 2, wherein said template is a blueprint for a set of collections that have the same attributes and similar themes.

6. The method of claim 2, further comprising the step of defining said template by verticals, categories, attributes, metrics, and text filters.

7. The method of claim 2, wherein said template is a global template that is applied to an online store to create a collection.

8. The method of claim 2, wherein said template is a local template that can only be applied within a store to create a collection.

9. The method of claim 2, wherein said template is a system template that is created by developers based on store metrics.

10. The method of claim 2, wherein said template is a trending template that creates collections of products that are top sellers.

11. The method of claim 2, wherein said template is a Brand Name Look Alike Template that is applied to said electronic catalog to create collections of products from a store that resemble high end branded products.

12. The method of claim 2, wherein said template is a celebrity template that is applied to said electronic catalog to create collections of products from a store’s catalogue that resemble outfits worn by celebrities.

13. The method of claim 2, wherein said templates are created by developers based on system metrics in combination with attributes, filters, metrics and categories.

14. The method of claim 2, wherein initial rules for template attributes are entered by a subject matter expert, and said subject matter expert can alter a collection by adding or removing items from said collection.

15. The method of claim 2, further comprising:
uploading image(s) via at least one computing device from a console or software application; and
qualifying, via the at least one computing device, a template derived from said image(s) by automatically selecting additional attributes based on image classification for each image uploaded.

16. A computer implemented system for creating an extended range of templates, wherein said templates are applied to an electronic catalog of a retailer to create a curated collection of items for an online consumer, comprising:
a master database that includes a database of a first set of templates, collection database, and catalog database, wherein events of user clicks, carts, and attribute data of said online consumer are merged into said master database, and wherein said electronic catalog is segmented and classified into a lowest category to reduce complexity;
a vector database that stores representations of themes mapped to attributes; and
a similarity search system comprising a memory that stores executable components, and a microprocessor that executes a get similar function applying vector similarity to find similar images for said first set of templates and thereafter creates and stores said extended range of templates.
